(19) United States
(12) Patent Application Publication
(10) Pub. No.: US 2004/0216048 A1
(43) Pub. Date: Oct. 28, 2004

(54) Method and computer program product for document management and publication using reusable packages and components

(76) Inventors: Jacqueline Tracey Brown, London (GB); Robert Martin Cregan, Harpenden (GB); Peter Michael Eshkeri, Herts (GB); Ian Harvey, Rochester (GB); Nilmini Murrell, Harefield (GB); Simon Seely, Bristol (GB)

Correspondence Address: GLAXOSMITHKLINE, Corporate Intellectual Property - UW2220, P.O. Box 1539, King of Prussia, PA, 19406-0939, US

(21) Appl. No.: 10/847,227

(22) Filed: May 17, 2004

Related U.S. Application Data
(63) Continuation of application No. 09/627,798, filed on Jul. 28, 2000, now abandoned.

(51) Int. Cl. G06F 17/21

(52) U.S. Cl. 715/530

(57) ABSTRACT

A method and computer program product for document management and publication using reusable packages and components. Reusable document components are created and stored in a repository along with descriptive information. Reusable logical groups of the reusable document components and are also stored in the repository along with descriptive information. Documents are created from the reusable document components and reusable logical groups and are stored in the repository along with descriptive information. Management of the publication of large numbers of dossiers is facilitated by the use of a hierarchy of reusable document components and reusable packages of components.

### BACKGROUND OF THE INVENTION

1. Field of the Invention

The present invention is directed to methods, systems, and computer program products for document management and more particularly, methods, systems, and computer program products for document management and publication using reusable packages and components.

2. Discussion of the Background

To maximize income from established marketed products, it is advantageous for pharmaceutical companies to effectively maintain their product marketing licenses, as well as capitalize on new market opportunities. The regulatory submissions (hereinafter referred to as Adossiers≅) required to maintain current product licenses and enter new markets are extensive. As the number of products and markets increases, the challenges increase accordingly. Commercially available document management systems are adaptable to assist in the production of regulatory dossiers. Such systems provide for the maintenance of a repository of documentation that form the basis for a dossier. One commercially available document management system is DOCUMENTUM, which provides (1) a mechanism for maintaining a repository of documents, and (2) tools for publishing documents (e.g., dossiers) from the repository. Document management tools such as DOCUMENTUM make use of commercially available database management systems (DBMSs) such as ORACLE, SYBASE, or MICROSOFT SQL SERVER to maintain information on the documents being managed. The documents themselves are typically created and maintained in standard word processing formats such as WORD or WORDPERFECT.

U.S. Pat. Nos. 5,734,883 and 5,963,967 disclose drug document production systems making use of templates to create documents and managing database information pertaining to the documents.

The challenges presented in creating very large dossiers of 50,000 pages or more required by regulators for a new drug application (NDA) are quite different than those presented by the regulatory requirements to maintain current products or to enter new markets with previously approved products. Typically, dossiers required for renewals, re-registration, or first registration of approved products in new markets are 1,000-2,000 pages, as compared to the 50,000 pages required for a NDA. However, a large pharmaceutical company may need to generate 1,000 or more of these smaller dossiers on any given year.

The challenge, then, as presently recognized, is to develop an approach that will facilitate the compilation of dossiers for approved products from an existing repository of approved and up-to-date documentation.

### SUMMARY OF THE INVENTION

The present inventors have recognized that by efficiently managing the submission information for its products, a pharmaceutical company can reduce document production time required to maintain its licenses and to enter new markets as they open. Accordingly, one object of the present invention is to provide an approach for efficiently reusing and repackaging approved and up-to-date submission information for renewals, re-registration, and first registrations in new markets. A further object of the present invention is to provide a secure repository for the reusable submission information.

The present inventors have also recognized that by decomposing NDA information into standardized components, and logically grouping those components, they will gain insights as to the impact of changes made to components of dossiers. Accordingly, a further object of the present invention is to provide an ability to perform an impact analysis as to which elements of a document hierarchy are impacted by a particular change to any given element in that hierarchy.

The inventors of the present invention have also recognized the benefits of creating standardized components and logically grouping those components. For example, local operating companies (LOCs) would be able to create their own regulatory dossiers from approved and up-to-date standard components. Accordingly, a further object of the present invention is to provide logical groupings of approved and up-to-date document components that could be utilized in a distributed organization.

### BRIEF DESCRIPTION OF THE DRAWINGS

A more complete appreciation of the present invention, and many of the attendant advantages thereof, will be readily obtained as the same becomes better understood by reference to the following detailed description when considered in connection with the accompanying drawings, wherein:

FIG. 1 is a schematic diagram of an electronics portion of the workstations used in the system;

FIG. 2 is a block diagram showing an overall system configuration for one embodiment of the present invention;

FIG. 3 is a block diagram showing mechanisms of a client work station and a document component server shown in FIG. 2;

FIG. 4 is an exemplary folder hierarchy showing the concept of component scope;

FIG. 5 is a block diagram showing the hierarchical relationships between objects used in the present invention;

FIG. 6 is a state transition diagram showing the life cycle of a component;

FIG. 7 is a state transition diagram showing the life cycle of a data package;

FIG. 8 is a state transition diagram showing the life cycle of a dossier;

FIG. 9 is a block diagram showing an exemplary logical grouping of objects for one embodiment of the present invention;

FIG. 10 is a block diagram showing an exemplary scope of the impact of a change to a component for one embodiment of the present invention;

FIG. 11 is a block diagram showing the exemplary creation of multiple dossiers from existing objects using one embodiment of the present invention;

FIG. 12 is a flow diagram of a process to create a new dossier; and

FIG. 13 is a flow diagram of a process to assess the impact of a change to an object.

### DESCRIPTION OF THE PREFERRED EMBODIMENTS

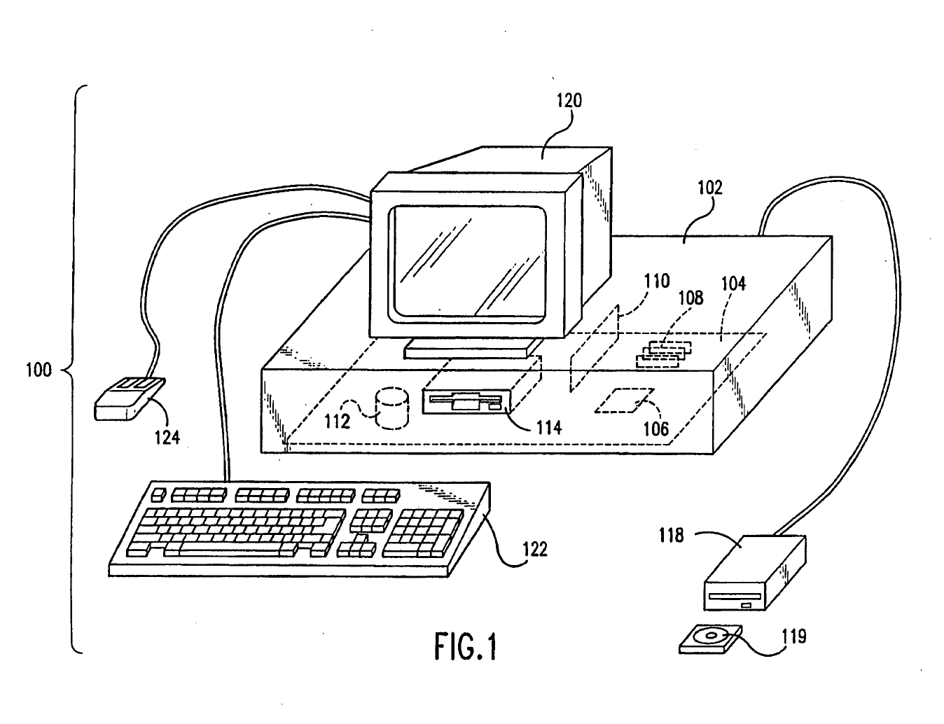

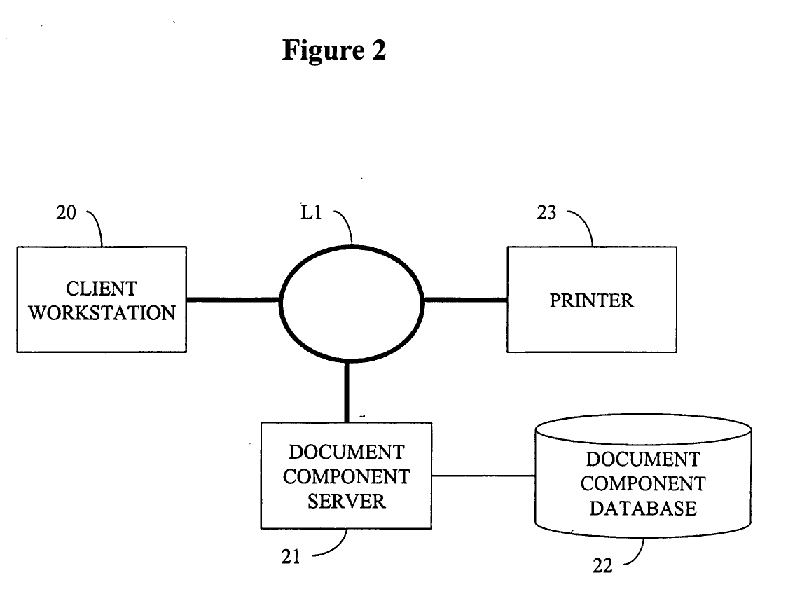

Referring now to the drawings, wherein like reference numerals designate identical or corresponding parts throughout the several views, FIG. 1 is a schematic illustration of a computer system for document management and publication using reusable packages and components. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer 23 in FIG. 2 also provides printed listings for impact analysis of changes to document components.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for document management and publication using reusable packages and components. The computer code devices of the present invention can be any interpreted or executable code mechanism, including but not limited to scripts, interpreters, dynamic link libraries, Java classes, and complete executable programs.

The present embodiment is discussed in the context of dossier publication for drugs that have already been approved. However, the invention may be used in other contexts, for example, any regulated business that must renew or re-register licenses, or that desires to register approved products in new markets.

As shown in FIG. 2, the system includes a network L1 including a client workstation 20, a document component server 21, a document component database 22, and a printer 23. The document component database 22 is a digital repository that may be implemented, for example, through a commercially available relational data base management system (RDBMS) based on the structured query language (SQL) such as ORACLE, SYBASE, INFORMIX, or MICROSOFT SQL SERVER, through an object-oriented database management system (ODBMS), or through custom database management software. In one embodiment, the document component database 22 contains all information of interest on the objects being maintained by the system. For example, the document component database includes information on the type of the object (e.g., component, data package, dossier), the name of the object, the status of the object, as well as other descriptive information such as important dates from the object's life cycle. Data in the document component database 22 is maintained by processes on the document component server 21. The document component database 22 may reside on a storage device of the document component server 21, or reside on another device connected to the document component server 21, for example by way of a local area network L1 or other communications link such as a virtual private network, wireless link, or internet-enabled link.

The client workstation 20 communicates with the document component server 21, for example by way of a local area network L1, although other communications links such as a virtual private network, wireless link, or internet-enabled link may be used as well. The client workstation 20 and the document component server 21 interact with the document component database 22 through various software applications. The information maintained in the document component database 22 may be accessed through a commercially available document management software application such as DOCUMENTUM. Other tasks may interact with the document component database 22 through custom application software to provide features not available through commercially available document management applications. Through commercially available document management software applications, the user is able to create document components that get cataloged to the document component database 22 by the document component server 21. Another software product, one embodiment of which is described by the inventors as “Maintenance Library,” or “ML,” is used to logically group document components created by the document management software into reusable packages that will facilitate dossier creation. Information pertaining to the packages created by ML is also stored in the document component database 22 by the document component server 21 as the result of commands issued by a user of the client workstation 20.

As described above, the system also includes a printer 23, or other output devices for use in creating deliverable products, or outputting reports to facilitate the document management process. By maintaining a comprehensive history of all document components and data packages included in delivered dossiers in the document component database 22, insightful reports can be generated and output to the printer 23 that will help in assessing impacts of changes to document components, or in creating new dossiers from pre-existing components or packages.

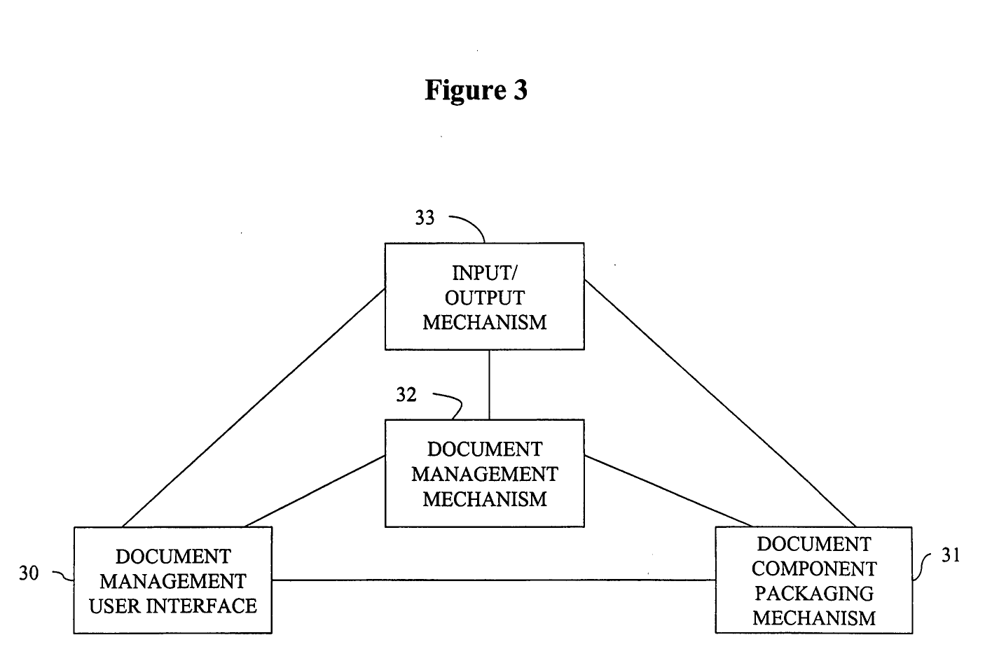

FIG. 3 shows the mechanisms implemented by the client workstation 20 and the document component server 21 in greater detail. The client workstation 20 and the document component server 21 include a document management user interface 30. The user of a client workstation 20 interacts with the system through the document management user interface 30. The document management user interface 30 presents information to, and receives information from, the user of the system and provides that information to the document component packaging mechanism 31 and the document management mechanism 32 which will then manipulate or display the information in the document component database 22 according to the user's direction. The input/output mechanism 33 provides a mechanism through which the ML software and the document management software can interact with external components. For example, the input/output mechanism 33 allows the client workstation 20 to connect to the network L1 through a remote connection.

The document management user interface 30 provides information and prompts to the user through the CRT 120, and the user provides input to the system through the keyboard 122 and mouse 124. The document management user interface 30, the document component packaging mechanism 31, and the document management mechanism 32 reside in the various memory elements of the computer 100 and cause the CPU 106 to process the information received from the external devices and the user to provide the desired functionality, displays, and output.

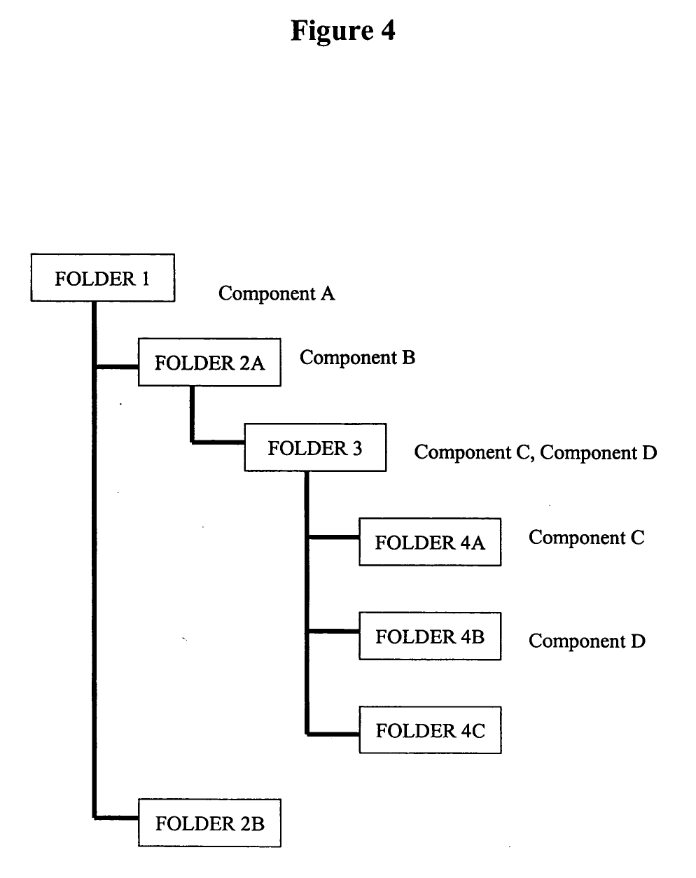

FIG. 4 illustrates the concept of scope as implemented through the document management mechanism 32. As shown in FIG. 4, document components are organized by the document management mechanism 32 into groups (e.g., hierarchical folders). Components that are contained in higher level groups apply to all groups subordinate to that group in the hierarchy unless the subordinate group contains the same component as determined by the component name. Therefore, as shown in FIG. 4, Component C exists in FOLDER 3, as well as FOLDERs 4B and 4C. The version of Component C that is in FOLDER 3 is not in FOLDER 4A since FOLDER 4A contains a component with the same name as Component C. FOLDER 4A, then, contains the same components as FOLDER 3, with the exception of a different version of Component C. The version of Component C that is in FOLDER 4A would have more specific content than the version of Component C contained in FOLDER 3. In general, the lower in the hierarchy a version of a Component exists, the more specific the content of that version of the Component. The concept of scope facilitates component reuse, since many dossiers contain many common components. Different versions of the same dossiers, for example, could be created by simply including different versions of the components where the dossier differences are isolated.

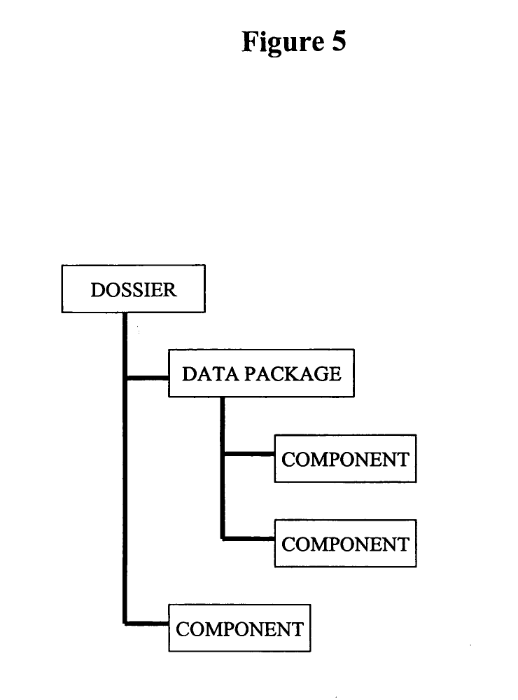

As shown in FIG. 5, the three main object types of the present invention are dossiers, data packages, and components. Components are simple documents that are typically created with a standard word processing application such as WORD or WORDPERFECT. However, components may also be other formats including, but not limited to, portable document format (PDF) or tag image file format (TIFF). The content of the components may be generic or specific. Generic components may be used in many data packages or dossiers, whereas specific components may be only used in a single data package or dossier.

These three object types are used by the ML system to maintain connectivity information on all dossiers published with the system. By maintaining this connectivity information, the system provides traceability for all dossiers published. The complexity of a dossier and the amount of reuse across dossiers make traceability an important feature of the ML system. Furthermore, by having the connectivity information pertaining to dossiers readily available from the ML system, crisis management (e.g., the need to republish dossiers due to new information or the identification of an error) may be undertaken more efficiently.

Data packages are virtual documents that group together, in a specific order, components. The grouping of logical sets of components facilitates reuse, and makes dossier creation quicker and easier.

Dossiers are virtual documents that group together, in a specific order, both data packages and components, and place the content in the order required by the user. The dossiers have to be customized according to the type of submission, market, and/or country. When creating dossiers, the user must be sensitive to the fact that components and data packages are intended for reuse, and therefore, cannot be modified to create a particular dossier. Therefore, when a dossier is being prepared for publishing, a copy of all the components will be made, so that dossier-specific customization may be made without impacting the reusability of the components.

The publication of a dossier by the ML system involves not only the determination of which components and data packages are to be included, but also considerable reformatting. A dossier published by the ML system includes each of the individual components making up the text of the dossier, but also is formatted to include, for example, proper pagination as a single document, a table of contents, as well as header and footer information throughout the document. Once the dossier is completed, a formatted file (e.g., a PDF file containing a concatenation of the individual components paginated as a single document with a table of contents) is generated, which can be printed on the printer 23.

Given the size of the dossiers, the concept of data packages facilitates the repetitive dossier creation. The data packages serve to collect common components so that the data package can be reused as opposed to reusing all of the member components. Managing component reuse at the data package level reduces not only the complexity of the component management required, but also the opportunities for making errors when creating a complex dossier. The document component packaging mechanism 31 maintains the data packages and stores information defining the data packages in the document component database 22.

As part of the document management process, the present invention enforces life cycles on each of the three main object types of the system (i.e., dossiers, data packages, components). By maintaining object life cycles, the ML system can enforce rules that will ensure that dossiers created by the ML system will contain only those data packages and components that have been through the requisite approval and review processes.

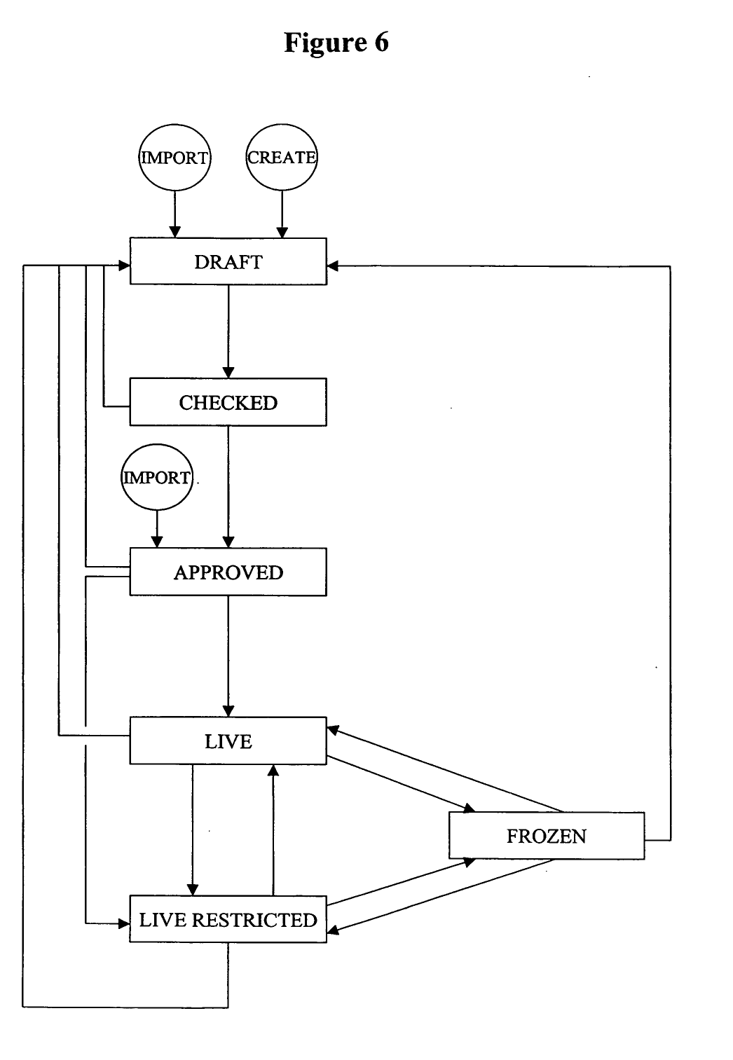

FIG. 6 shows a life cycle for a component object in one embodiment of the present invention. As shown in FIG. 6, a component may be imported into the ML system in either a state of “DRAFT” or “APPROVED.” New components that are created within the ML system are created in an initial state of “DRAFT.” A component may remain in the state of “DRAFT” for several iterations before advancing to the state of “CHECKED,” for example, as the component is being originally drafted. The normal life cycle for a component in the ML system is from “DRAFT” to “CHECKED” to “APPROVED” to “LIVE.” As an example of business rules that can be imposed in the ML system, rules could be written that would only allow modifications to a component when that component is in a “DRAFT” or “CHECKED” state. The ML system may also impose business rules based on established roles of the user of the system. For example, certain users may not have the appropriate authority to move a component from a “CHECKED” state to an “APPROVED” state. By enforcing the appropriate rules, the ML system can ensure that only those components that have been reviewed by the appropriate users may be included in a particular dossier. Also illustrated in FIG. 6 is the use of a component state to impact how an approved component is used. For example, as shown in FIG. 6, components that have been “APPROVED” may be in any one of “LIVE,” “LIVE RESTRICTED,” or “FROZEN” states. By defining business rules associated with each of these three states, the ML system can affect how different components are used in future dossiers.

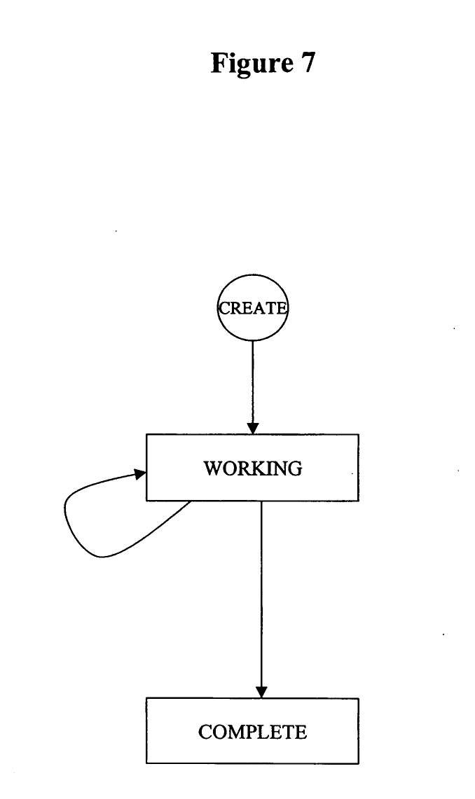

FIG. 7 shows an object life cycle for a data package object in one embodiment of the present invention. As shown in FIG. 7, a data package object may be in a “WORKING” or “COMPLETE” state. As discussed above, business rules may be defined so that the ML system may enforce which data package objects get included in a particular dossier, as well as defining the rules of which users may change the state of a particular data package from “WORKING” to “COMPLETE.” As an example, a business rule may be defined through which the ML system will prevent the modification of the structure (i.e. which components it contains) of a data package where that data package is in a “COMPLETE” state. In this way, data packages of can be baselined as containing a defined set of components for use in multiple dossiers without the need for regrouping those components into a logical package.

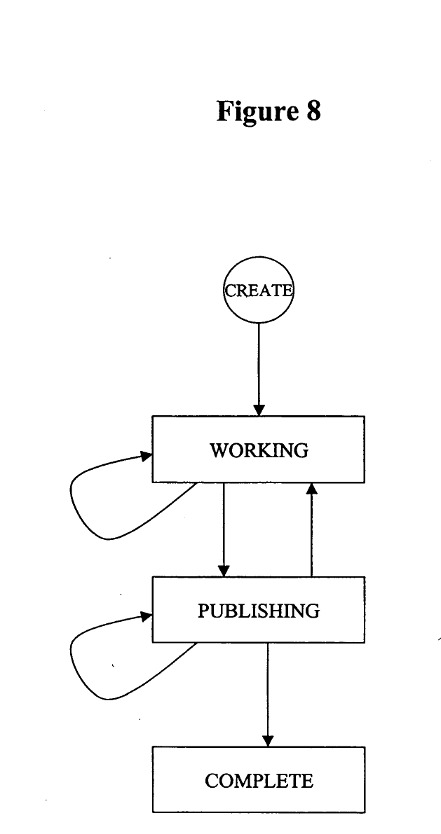

FIG. 8 shows a life cycle diagram for a dossier in one embodiment of the present invention. As shown in FIG. 8, a dossier may be in any one of the “WORKING,” “PUBLISHING,” or “COMPLETE” states. As discussed above, business rules may be defined that will allow the ML system to enforce which users have the appropriate role to transition a particular dossier from one state to another. As an example, a rule may be written wherein a particular dossier will be prevented from transitioning to a “COMPLETE” state unless all data packages that are included in that dossier are in a “COMPLETE” state, and all components included in that dossier, either directly or as a member of an included data package, are themselves in a “LIVE” or “LIVE RESTRICTED” state.

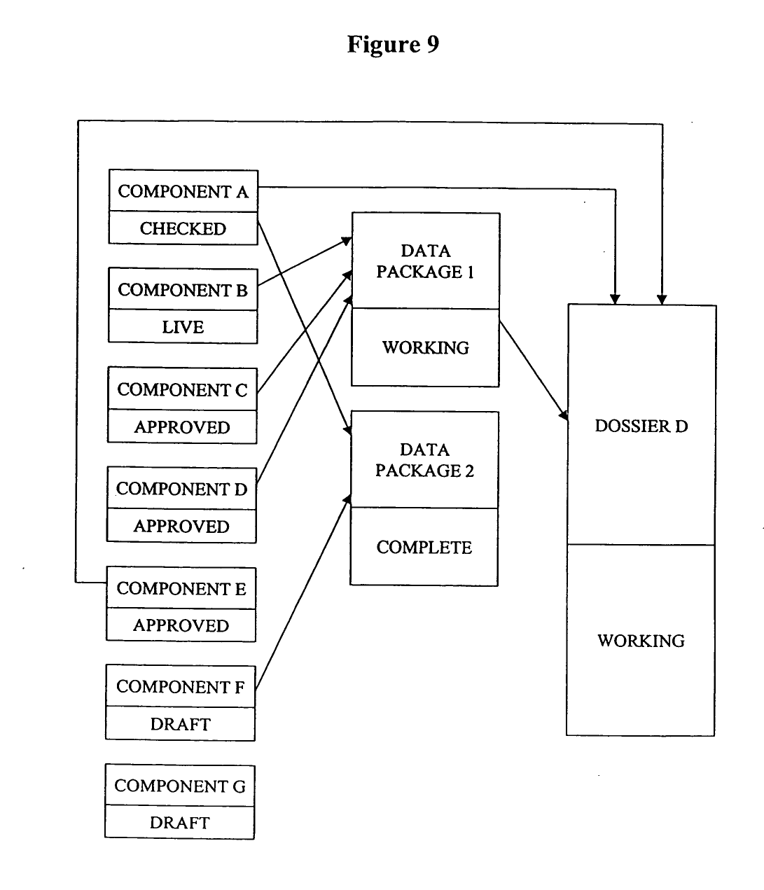

FIG. 9 illustrates the relationship between components, data packages, and dossiers in one embodiment of the present invention. As shown in FIG. 9, “DOSSIER D” may include “COMPONENT A,” “COMPONENT E,” and “DATA PACKAGE 1.” “DATA PACKAGE 1” may be made up of “COMPONENT B,” “COMPONENT C,” and “COMPONENT D.” By including “DATA PACKAGE 1” in “DOSSIER D,” it was unnecessary to individually include “COMPONENT B,” “COMPONENT C,” and “COMPONENT D.” Having the data package groupings of components facilitates the creation of dossiers that typically include many common components.

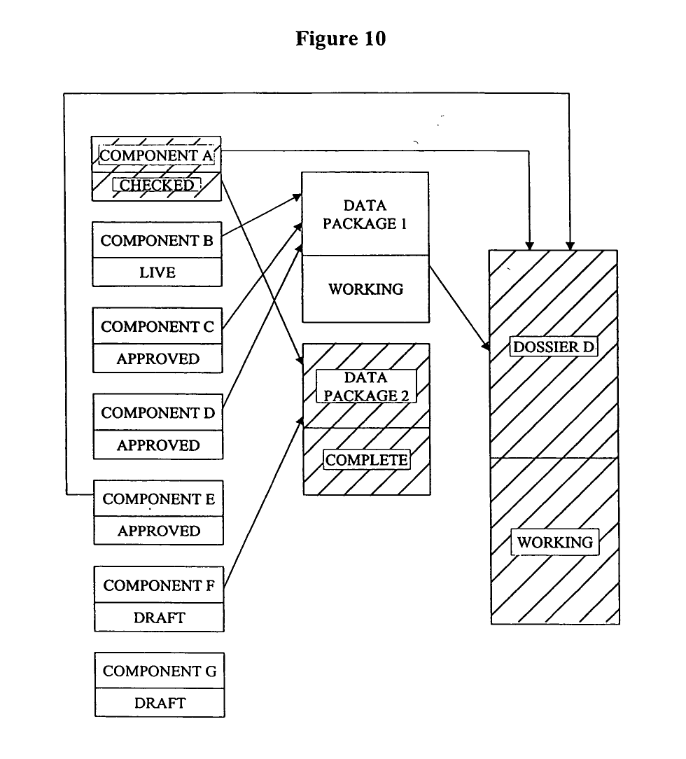

As shown in FIG. 10, by maintaining information on relationships between components, data packages, and dossiers, the ML system facilitates impact analysis of changes made to a particular component. As shown in FIG. 10, if a problem were identified with “COMPONENT A,” that problem would also be present in “DATA PACKAGE 2” as well as in “DOSSIER D.”

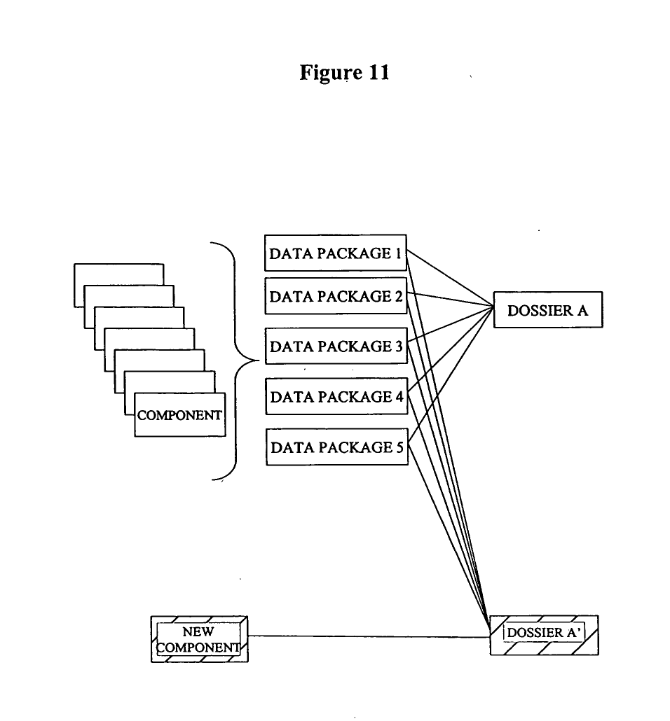

FIG. 11 illustrates the benefits that may be derived by using data packages.

As shown in FIG. 11, “DOSSIER A” is made up of five separate data packages (i.e., “DATA PACKAGE 1”—“DATA PACKAGE 5”). By including the five data packages, the complexity of building a dossier has been significantly reduced, since from a component prospective, “DOSSIER A” may be made up of hundreds or thousands of individual components. Furthermore, many of the data packages may be widely reusable as shown in the creation of “DOSSIER A.” “DOSSIER A” may be created by simply including the same five data packages that were used to create “DOSSIER A.” In addition to the components that were contained in the five data packages included in “DOSSIER A,” “DOSSIER A” may also contain a new component which can be simply added to complete the new dossier. In a business where thousands of dossiers are to be created, the ability to create dossiers from reusable data packages, as compared to thousands of reusable components, can not only improve the efficiency of creating dossiers, but also improve the quality by reusing groups of approved and up-to-date components.

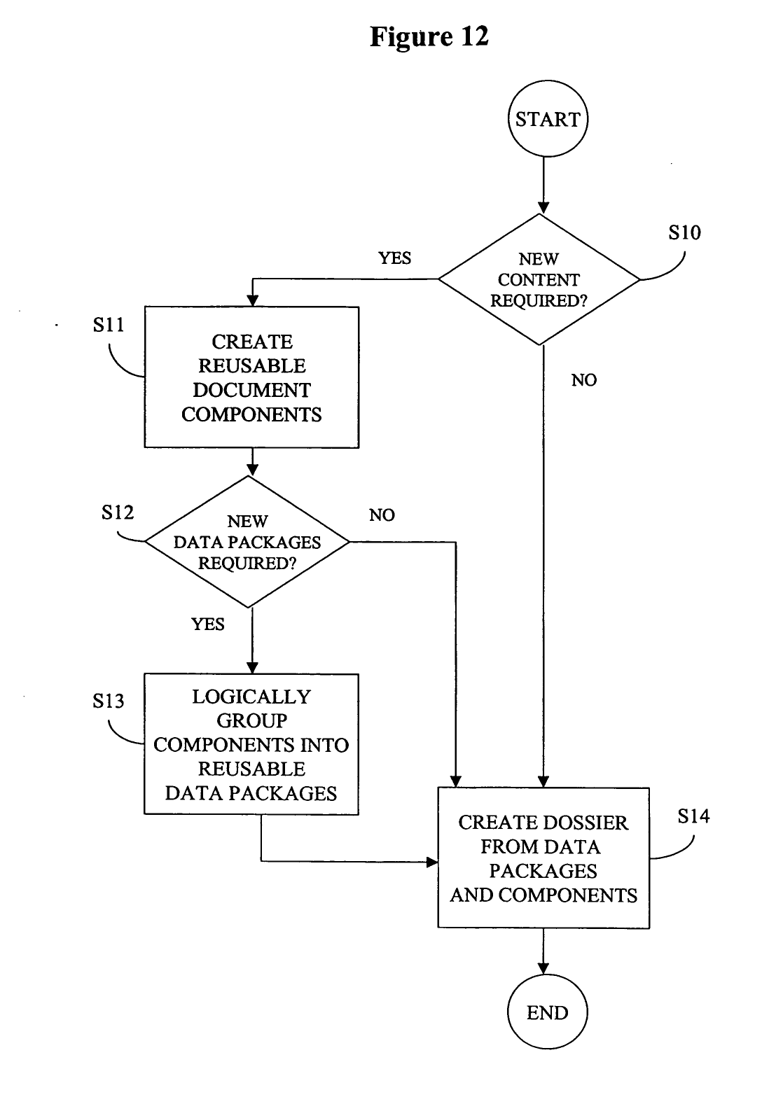

FIG. 12 shows a process through which new dossiers are created using the present invention. As shown in FIG. 12, the process begins at step S10 where it is determined whether new content is required to create the dossier. If new content is required, the process proceeds to step S11 where reusable document components are created. After the new content has been created in new document components, the process proceeds to step S12 where it is determined if new reusable data packages are to be created. If it is determined that the new content should be grouped into new data packages to facilitate reuse, or if the new content should be grouped into existing data packages, the process proceeds to step S13 where data packages are created from logical groups of components. The creation of reusable data packages at step S13 may involve the creation of new data packages, or as discussed above, involve adding new content to existing reusable data packages. If it is determined at step S12 that new data packages are not required, or after the grouping performed at step S13, the process proceeds to step S14 where a new dossier is created from reusable data packages and reusable components. Similarly, if it is determined at step S10 that new content is not required, the process proceeds directly to step S14 where a new dossier can be created solely from existing data packages and components.

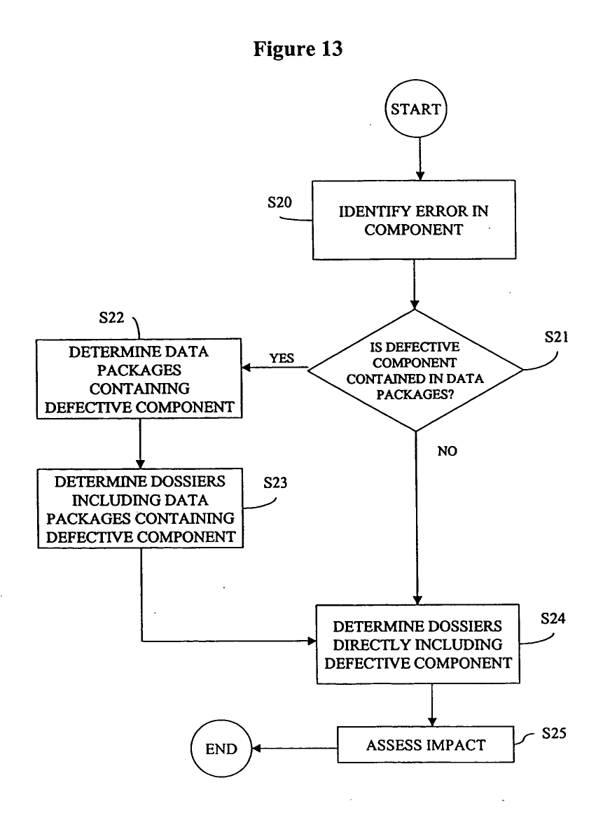

FIG. 13 shows a process through which the impact of an error identified in a component may be assessed. As shown in FIG. 13, the process begins at step S20 where an error is identified in a component. Once an error has been identified, the process proceeds to step S21 where it is determined whether the component is contained in any reusable data packages. If it is determined that the component is contained in reusable data packages, the process proceeds to step S22 where it is determined which packages contain the defective component. The process then proceeds to step S23 where it is determined which dossiers include the reusable data packages that contain the defective component. If it is determined at step S21 that the defective component was not contained in any reusable data packages, or after determining which dossiers include data packages containing the defective component at step S23, the process proceeds to step S24 where it is determined which dossiers directly include the defective component. Once it has been determined which dossiers include, either directly or as a member of a reusable data package, a defective component, the process proceeds to step S25 where the impact is assessed.

Once it has been determined which document components are affected, and which dossiers include those document components, a determination is made as to which of those dossiers have been printed and sent to customers (e.g., regulators). By accessing information maintained in the document component database 22, a determination is made as to which components need to be updated as well as to which customers updates must be sent. Once the affected document components have been identified, those components are modified under the same controls that were imposed during their creation. As an example, an affected document component may be moved from a ALIVE≅ state back to a ADRAFT≅ state, as shown in FIG. 6, by a user having the appropriate role. Once the document component has been modified and moved through its life cycle to a state of “LIVE” or “LIVE RESTRICTED,” and all of the data packages to be included in the new dossier are in a state of “COMPLETE,” a new version of those dossiers including the affected document component may be published and sent out. By maintaining all pertinent information in the document component database 22, the ML system facilitates a quick and controlled response to necessary changes (e.g., due to changes in regulations, or dangers that have been discovered) that require updates to published dossiers.

The processes set forth in the present description may be implemented using a conventional general purpose microprocessor program according to the teachings in the present specification, as will be appreciated to those skilled in the relevant arts. Appropriate software coding can be readily prepared by skilled programmers based on the teachings of the present disclosure, as will also be apparent to those skilled in the relevant arts.

The present invention thus also includes a computer-based product which may be hosted on a storage medium and include instructions that can be used to program a computer to perform a process in accordance with the present invention. The storage medium can include, but is not limited to, any type of disk including floppy disk, optical disks, CD ROMs, magneto-optical disks, ROMs, RAMs, EPROMs, EEPROMs, flash-memory, magnetic or optical cards or any type of media suitable for storing electronic instructions.

Obviously, numerous modifications and variations of the present invention are possible in light of the teachings. It is therefore to be understood that within the scope of the appended claims, the invention may be practiced otherwise than as specifically described herein.

1. A method of creating a document from reusable document components and logical data packages, comprising the steps of:
creating plural reusable document components;
storing the plural reusable document components in a digital repository;
populating said digital repository with document component descriptors associated with the plural reusable document components, the document component descriptors each adapted to be associated with one of the plural reusable document components and having a document identification indicator, and at least one document characteristic attribute indicator;
creating plural reusable logical data packages containing at least one of the document components;
populating the digital repository with data package descriptors associated with the plural reusable logical data packages, said data package descriptors each being associated with one of the plural reusable logical data packages, and being associated with at least one of the plural reusable document components, and having a package identification indicator, and at least one package characteristic attribute indicator;
populating said digital repository with document descriptors, said document descriptors each being associated with at least one of at least one of the document component descriptors, and at least one said data package descriptors; and
creating a document by selecting the document components corresponding to said document descriptor in said digital repository.

2. The method of claim 1, wherein:
the step of storing comprises storing the plural reusable document components in a database.

3. The method of claim 1, wherein:
the step of creating a document further comprises the step of recording in the digital repository at least one of (1) a date of most recent modification, and (2) which versions of the document component descriptors and logical package descriptors are included in the document.

4. The method of claim 3, further comprising the steps of:
updating one of the document component descriptors and logical package descriptors based on an update to one of the document component descriptors and logical package descriptors;
searching the digital repository for documents generated prior to the update; and
regenerating the documents using the updated one of the document component descriptors and logical package descriptors.

5. A computer program product, comprising:
a computer storage medium and a computer program code mechanism embedded in the computer storage medium for causing a processor to facilitate the reuse of document components and logical groups of document components to publish complex documents, the computer program code mechanism comprising:
a first computer code device configured to create reusable document components;
a second computer code device configured to store the reusable document components in a digital repository along with descriptive information about the reusable document components;
a third computer code device configured to create reusable logical groupings of the reusable document components;
a fourth computer code device configured to store the reusable logical groupings of the reusable document components in the digital repository along with descriptive information about the reusable logical groupings of the reusable document components;
a fifth computer code device configured to create documents from the reusable document components and the reusable logical groupings of the reusable document components;
a sixth computer code device configured to store the documents in the digital repository along with descriptive information about the documents.

6. The computer program product of claim 5, wherein:
the digital repository comprises a database.

7. A system for creating a document from reusable document components and logical data packages, comprising:
means for creating plural reusable document components;
means for storing the plural reusable document components in a digital repository;
means for populating said digital repository with document component descriptors associated with the plural reusable document components, the document component descriptors each adapted to be associated with one of the plural reusable document components and having a document identification indicator, and at least one document characteristic attribute indicator;
means for creating plural reusable logical data packages containing at least one of the document components;
means for populating the digital repository with data package descriptors associated with the plural reusable logical data packages, said data package descriptors each being associated with one of the plural reusable logical data packages, and being associated with at least one of the plural reusable document components, and having a package identification indicator, and at least one package characteristic attribute indicator;
means for populating said digital repository with document descriptors, said document descriptors each being associated with at least one of at least one of the document component descriptors, and at least one said data package descriptors; and
means for creating a document by selecting the document components corresponding to said document descriptor in said digital repository.
